(19) United States
(12) Patent Application Publication
(10) Pub. No.: US 2009/0054228 A1
(43) Pub. Date: Feb. 26, 2009

(54) CATALYST

(75) Inventors: Masao ICHIKAWA, Hiki-gun (JP); Kenji OKAMOTO, Nerima-ku (JP); Terumi FURUTA, Tokorozawa-shi (JP); Ryogo SAKAMOTO, Wako-shi (JP); Kaoru OMICHI, Asaka-shi (JP)

Correspondence Address: LAHIVE & COCKFIELD, LLP;FLOOR 30, SUITE 3000, ONE POST OFFICE SQUARE, BOSTON, MA, 02109, US

(73) Assignee: HONDA MOTOR CO., LTD., Tokyo (JP)

(21) Appl. No.: 12/195,926

(22) Filed: Aug. 21, 2008

(30) Foreign Application Priority Data
Aug. 22, 2007 (JP) 2007-215771

(51) Int. Cl. B01J 23/06; B01J 23/42; B01J 23/16; B01J 23/26; B01J 23/28; B01J 23/30; B01J 23/34; B01J 23/745; B01J 23/75; B01J 23/755

(52) U.S. Cl. 502/313; 502/339; 502/326; 502/329; 502/331; 502/324

(57) ABSTRACT

A catalyst has an underlayer and a platinum layer formed thereon. The underlayer contains a transition metal other than platinum group metals or an alloy thereof. The platinum layer, which contains platinum, has a thickness of at least 0.4 nm but less than 1 nm.

### BACKGROUND OF THE INVENTION

1. Field of the Invention

The present invention relates to a catalyst for accelerating an oxidation-reduction reaction, more specifically to a catalyst suitable particularly for use in an electrode catalyst layer of an electrode in a fuel cell.

2. Description of the Related Art

Fuel cells are generally composed of a stack of a plurality of unit power generation cells. The unit power generation cell is obtained by sandwiching an electrolyte-electrode assembly between a pair of separators, and the electrolyte electrode assembly is prepared by interposing an electrolyte between an anode and a cathode.

Each of the anode and cathode has a gas diffusion layer of a carbon paper or the like, and an electrode catalyst layer. The electrode catalyst layer is formed by uniformly applying catalyst-supporting carbon particles to the gas diffusion layer, and is attached to the electrolyte.

The unit power generation cell is heated to a predetermined temperature, a fuel gas containing hydrogen is supplied to the thus-formed anode, and an oxygen-containing gas is supplied to the cathode, so that the unit cell generates electricity. In the anode, the hydrogen in the fuel gas is introduced through the gas diffusion layer to the electrode catalyst layer, and is ionized by the oxidation reaction of the following formula (1).

2H₂→4H⁺+4e (1)

In the formula (1), e represents an electron.

The generated proton is conducted in the electrolyte to the electrode catalyst layer of the cathode. In the cathode, the oxygen-containing gas is introduced through the gas diffusion layer to the electrode catalyst layer. Further, the electron is moved to the cathode by applying external load, so that the oxygen in the oxygen-containing gas is reduced by the proton and the electron. Thus, the reduction reaction of the following formula (2) proceeds in the electrode catalyst layer of the cathode.

O₂+4H⁺+4e→2H₂O (2)

The catalyst supported on the carbon particle accelerates the oxidation and reduction reactions of the formulae (1) and (2). In other words, the proton and water are efficiently generated due to the presence of the catalyst.

Platinum (Pt) has been widely used as this kind of catalyst. However, the platinum is expensive as is well known in the art, and the use of a large amount of the platinum results in a high fuel cell price and an increased power generation cost.

In Japanese Laid-Open Patent Publication No. 2006-128117, a transition metal core is coated with a platinum-containing surface layer, whereby the used amount of platinum is reduced. According to the Japanese Laid-Open Patent Publication No. 2006-128117 (see paragraph [0024]), it is preferred that the surface layer has a thickness of 1 to 5 nm.

### SUMMARY OF THE INVENTION

A general object of the present invention is to provide a catalyst having a higher activity.

A principal object of the present invention is to provide a catalyst using a smaller amount of platinum.

According to an aspect of the present invention, there is provided a catalyst for accelerating an oxidation-reduction reaction, comprising an underlayer and a platinum layer formed thereon, wherein the underlayer comprises a transition metal other than platinum group metals or an alloy thereof, and the platinum layer has a thickness of at least 0.4 nm but less than 1 nm. The platinum group metals include Ru, Rh, Pd, Os, Ir, and Pt, as is known in the art.

In the present invention, since the platinum layer has a thickness within the above range, the catalyst requires only a remarkably small amount of platinum. Thus, the used amount of the expensive platinum can be greatly reduced in the present invention, and the catalyst of the present invention is advantageous in cost.

When the platinum layer has a thickness of 0.4 nm or more, elution of the transition metal in the underlayer can be effectively prevented. Further, the catalyst of the present invention having a platinum layer thickness of less than 1 nm is more excellent in catalytic activity than conventional ones having a platinum layer thickness of 1 nm or more.

Thus, by controlling the thickness of the platinum layer within the range of at least 0.4 nm and less than 1 nm, the cost of the catalyst can be reduced without deterioration of catalytic activity.

The catalyst of the present invention having such a structure can accelerate both of an oxidation reaction and a reduction reaction. Therefore, the catalyst can be suitably used in an electrode of a fuel cell. Of course, by using the catalyst, the power generation property of the fuel cell can be improved while reducing its production cost.

In the catalyst, the underlayer (the transition metal) is hardly eluted even under a highly acidic atmosphere. Therefore, the catalyst can maintain excellent catalytic activity over a long period even when it is used in a cathode of a fuel cell.

Preferred examples of the transition metals include Co, Ni, Fe, and Cu. In the case of using the preferred metal, the catalyst can greatly accelerate an oxidation-reduction reaction.

The above and other objects, features, and advantages of the present invention will become more apparent from the following description when taken in conjunction with the accompanying drawings in which preferred embodiments of the present invention are shown by way of illustrative examples.

### DESCRIPTION OF THE PREFERRED EMBODIMENTS

Preferred embodiments of the catalyst of the present invention will be described in detail below.

A catalyst according to a first embodiment of the present invention has a film of an underlayer and a film of a platinum layer formed thereon.

The underlayer comprises a transition metal other than platinum group metals (i.e., Ru, Rh, Pd, Os, Ir, and Pt). Specific examples of such transition metals include Ti, V, Cr, Mn, Fe, Co, Ni, Cu, Zn, Mo, W, and Zr. It is particularly preferred that the underlayer comprises Co, Ni, Fe, or Cu, because the electronic state of such metals is greatly changed at the interface between the underlayer and the platinum layer (Pt), so that an oxidation-reduction reaction is significantly accelerated.

The platinum layer comprises Pt, and has a thickness of at least 0.4 nm but less than 1 nm. Thus, the thickness of the platinum layer according to this embodiment is smaller than those of the conventional surface layers (1 to 5 nm) described in Japanese Laid-Open Patent Publication No. 2006-128117.

Since the platinum layer has such a small thickness, an electron can be transferred between the platinum and the transition metal in the vicinity of the interface between the platinum layer and the underlayer. As a result, the electron configurations are changed in the vicinity of the interface.

Since the platinum layer has a small thickness of at least 0.4 nm and less than 1 nm as described above, finally the electron configurations are changed also in the surface of the platinum layer. As a result, the electronic state of the platinum layer formed on the underlayer according to this embodiment is different from those of a catalyst composed of only platinum and a catalyst composed of platinum layers having a thickness of 1 nm or more formed on an underlayer.

The platinum layer according to this embodiment, which is placed in this electronic state, is more excellent in catalytic activity than conventional ones having a thickness of 1 nm or more. For example, when hydrogen is brought into contact with the surface of the platinum layer, oxidation of the hydrogen is accelerated under catalytic action of the platinum layer. When oxygen is brought into contact with the surface, reduction of the oxygen is accelerated under the action of the platinum layer. Thus, the catalyst according to this embodiment can be used for both of the oxidation and reduction reactions. Therefore, such a catalyst can be suitably used for an electrode catalyst layer of the fuel cell in which the above oxidation and reduction reactions of the formulae (1) and (2) are carried out in an anode and a cathode, respectively.

The catalyst is excellent particularly in oxygen-reducing ability. Thus, the catalyst is particularly suitable for use in the electrode catalyst layer of the cathode.

The electrode catalyst layer of the fuel cell is exposed to a highly acidic atmosphere. In this embodiment, since the platinum layer has a thickness of 0.4 nm or more, the underlayer can be reliably protected by the platinum layer from the highly acidic atmosphere. As a result, elution of the transition metal of the underlayer can be prevented.

Furthermore, since the platinum layer has a thickness of at least 0.4 nm and less than 1 nm, smaller than those of conventional ones, the amount of the expensive Pt used is accordingly reduced. Thus, the catalyst of this embodiment is advantageous in cost.

For example, the platinum layer may be formed on the underlayer film by an arc plasma gun. The arc plasma gun is a well-known technique, by which a high voltage is applied using a metal as a cathode to excite a pulse discharge, thereby generating a plasma of the metal and the metal is then deposited on a substrate.

In this case, a base is placed in a vacuum vessel having a first arc plasma gun and a second arc plasma gun. The first arc plasma gun has a cathode of a transition metal, and the second arc plasma gun has a cathode of platinum.

Internal air is evacuated from the vessel, and the first arc plasma gun is driven, so that the transition metal film is deposited on the base to have a predetermined thickness. The underlayer is thus formed.

Then, the second arc plasma gun is driven, so that the platinum is deposited on the underlayer. The deposition is continued until the platinum thickness becomes within the range of at least 0.4 nm and less than 1 nm, whereby the platinum layer is formed to obtain the catalyst. The thicknesses of the underlayer and the platinum layer can be controlled by appropriately selecting the vacuum degree of the vessel, the capacitor capacitance of each arc plasma gun, the voltage for exciting the discharge, the discharge voltage, and the discharge period.

Of course, the platinum may be deposited to a thickness of at least 0.4 nm and less than 1 nm, on a base composed of the transition metal.

Though the catalyst of the above first embodiment is composed of laminated films, the underlayer may comprise a particle (second embodiment). That is, a catalyst according to the second embodiment has an underlayer comprising a transition metal particle, the surface of the underlayer being covered with a platinum layer. In this embodiment, the transition metal particle of the underlayer may be dispersed and supported on a surface of another particle such as a carbon particle. The platinum layer may be a layer laminated on the underlayer (a film with which the underlayer may be covered).

For example, the catalyst of the second embodiment having such a structure may be produced as follows. First, a transition metal salt or a hydrate thereof is reduced in the presence of a reducing agent in an organic solvent or water, thereby generating a nanoparticle of the transition metal.

When a carbon particle such as a carbon black is present in this reduction system, the nanoparticle is generated such that the nanoparticle is supported on a surface of the carbon particle. The carbon particle supporting the transition metal nanoparticle on the surface is hereinafter referred to as “a nanoparticle-supporting carbon particle”.

The obtained nanoparticle or the nanoparticle-supporting carbon particle is added to an organic solvent or water together with a platinum salt or a hydrate thereof, and the mixture is heated. Under the heating, the transition metal is oxidized at the surface of the nanoparticle (which may be supported on the carbon particle), and the platinum salt is reduced. Specifically, platinum is substitution-deposited on the surface of the transition metal to obtain the catalyst having the underlayer of the transition metal and the platinum layer formed thereon.

Though a simple substance of a metal (a transition metal) is used as a material of the underlayer in the above first and second embodiments, the underlayer may comprise an alloy of the above-described transition metals. Preferred examples of such alloys include Ti—W alloys, Ti—Ni alloys, Ti—Co alloys, Ti—V alloys, Ti—Mo alloys, W—Zr alloys, W—Cr alloys, and W—Ni alloys.

The application of the catalyst is not particularly limited to the use in the electrode catalyst layer of the anode or cathode of the fuel cell. The catalyst can be used for an oxidation or reduction reaction in various environments.

### EXAMPLE 1

A first arc plasma gun having a Co cathode and a second arc plasma gun having a Pt cathode were disposed in a vacuum vessel, and a rotating electrode base having a diameter of 5 mm and a thickness of 4 mm, composed of a glassy carbon, was attached to a jig in the vessel. The vacuum vessel was evacuated to a pressure of 1×10⁻⁴ Pa, and pulse discharge was carried out using a capacitor having a capacitance of 8800 μF under a discharge excitation voltage of 3 kV, a discharge voltage of 100 V, and a discharge frequency of 1 Hz, whereby Co was deposited in an amount corresponding to 1000 pulses, on the flat upper surface of the glassy carbon base, to form a Co underlayer.

Then, a platinum layer was formed on the underlayer under the same conditions as above except that Pt was deposited in an amount corresponding to 50 pulses using the second arc plasma gun, whereby a catalyst was produced. Two samples having the glassy carbon base and the catalyst formed thereon (hereinafter referred to as “catalyst-containing electrodes”) were produced in this manner.

Catalyst-containing electrodes having different platinum layer thicknesses were produced in the same manner as above except that the pulse number was 30, 18, 10, or 5 in the Pt deposition process, respectively. Two samples of each catalyst-containing electrode were produced, and one sample was used in a transmission electron microscopy (TEM) analysis for measuring the thicknesses of the underlayer and the platinum layer.

The other sample was subjected to a catalytic activity evaluation and a measurement of the amount of the underlayer (the transition metal) eluted. Specifically, the catalyst-containing electrode was immersed in a nitrogen-saturated sulfuric acid aqueous solution (0.5 mol/l), and 100-cycle scanning was carried out using a platinum electrode as a counter electrode at a scanning rate of 200 mV/second at a potential of 0 to 1 V higher than the standard hydrogen electrode potential, whereby the surface of the catalyst-containing electrode was cleaned. Then, the catalytic activity of the catalyst-containing electrode was evaluated by a linear sweep voltammetry measurement.

In the linear sweep voltammetry, in 300 ml of an oxygen-saturated sulfuric acid aqueous solution (0.5 mol/l), the catalyst-containing electrode was rotated under oxygen bubbling for 3 minutes. Then, the 1-cycle current value was measured using a platinum electrode as a counter electrode at a scanning rate of 5 mV/second at a potential of 0 to 1 V higher than the standard hydrogen electrode potential. The catalytic activity was evaluated based on the absolute value of the current value at a potential of 0.7 V higher than the standard hydrogen electrode potential.

Each sample was subjected to the linear sweep voltammetry measurement ten times, the electrolytic solution, i.e., the oxygen-saturated sulfuric acid aqueous solution, was collected and subjected to an inductively-coupled plasma mass spectrometry, and the amount of the transition metal contained in the electrolytic solution (the amount of the eluted transition metal) was determined.

The relations of the current value and the eluted transition metal amount to the pulse number used in the formation of the platinum layer and the platinum layer thickness are shown in Table 1. In Table 1, a sample with a larger current value has a higher catalytic activity, and a sample with a smaller transition metal amount has a low elution amount from the underlayer.

TABLE 1

| | Pt | | Current | | |
|---|---|---|---|---|---|
| | | Layer | value at | Amount of | |
| | Pulse | thickness | 0.7 V | eluted Co | |
| Underlayer | number | [nm] | [mA] | [ng/ml] | Evaluation |
| Co | 50 | 2.0 | 0.816 | 0 | good |
| | 30 | 1.2 | 0.817 | 0 | good |
| | 18 | 0.9 | 0.901 | 0 | excellent |
| | 10 | 0.4 | 0.910 | 0 | excellent |
| | 5 | 0.3 | 0.211 | 12 | poor |

Catalyst-containing electrodes having different platinum layer thicknesses were produced and subjected to a catalytic activity evaluation and an underlayer elution amount measurement in the same manner as above except that the first arc plasma gun had a cathode of Ni, Fe, or Cu to form an Ni, Fe, or Cu layer as the underlayer, respectively. The results are shown in Tables 2 to 4.

TABLE 2

| | Pt | | Current | | |
|---|---|---|---|---|---|
| | | Layer | value at | Amount of | |
| | Pulse | thickness | 0.7 V | eluted Ni | |
| Underlayer | number | [nm] | [mA] | [ng/ml] | Evaluation |
| Ni | 50 | 2.0 | 0.819 | 0 | good |
| | 30 | 1.2 | 0.817 | 0 | good |
| | 18 | 0.9 | 0.900 | 0 | excellent |
| | 10 | 0.4 | 0.902 | 0 | excellent |
| | 5 | 0.3 | 0.198 | 13 | poor |

TABLE 3

| | Pt | | Current | | |
|---|---|---|---|---|---|
| | | Layer | value at | Amount of | |
| | Pulse | thickness | 0.7 V | eluted Fe | |
| Underlayer | number | [nm] | [mA] | [ng/ml] | Evaluation |
| Fe | 50 | 2.0 | 0.820 | 0 | good |
| | 30 | 1.2 | 0.819 | 0 | good |
| | 18 | 0.9 | 0.903 | 0 | excellent |
| | 10 | 0.4 | 0.911 | 0 | excellent |
| | 5 | 0.3 | 0.200 | 14 | poor |

TABLE 4

| | Pt | | Current | | |
|---|---|---|---|---|---|
| | | Layer | value at | Amount of | |
| | Pulse | thickness | 0.7 V | eluted Cu | |
| Underlayer | number | [nm] | [mA] | [ng/ml] | Evaluation |
| Cu | 50 | 2.0 | 0.812 | 0 | good |
| | 30 | 1.2 | 0.816 | 0 | good |
| | 18 | 0.9 | 0.904 | 0 | excellent |
| | 10 | 0.4 | 0.907 | 0 | excellent |
| | 5 | 0.3 | 0.199 | 12 | poor |

It is clear from Tables 1 to 4 that the catalyst with a platinum layer thickness of at least 0.4 nm and less than 1 nm has a high catalytic activity and a small underlayer elution amount.

For comparison, platinum layers were formed on a Pt underlayer at a pulse number of 50, 20, or 5 respectively. As shown in Table 5, the thicknesses of the platinum layers could not be measured.

TABLE 5

| | Pt | | Current | | |
|---|---|---|---|---|---|
| | | Layer | value at | Amount of | |
| | Pulse | thickness | 0.7 V | eluted Pt | |
| Underlayer | number | [nm] | [mA] | [ng/ml] | Evaluation |
| Pt | 50 | Unmeasurable | 0.816 | 0 | good |
| | 20 | Unmeasurable | 0.821 | 0 | good |
| | 5 | Unmeasurable | 0.813 | 0 | good |

### EXAMPLE 2

Nickel acetate tetrahydrate and carbon black particles (trade name: Valcan X72) were added to ethylene glycol, and the mixture was heated up to 180° C. while stirred by a magnet stirrer and was then held at 180° C. for 30 minutes while stirred by a magnet stirrer. The mixture was cooled to room temperature, and the product was separated from the ethylene glycol by filtration, and was observed by TEM. As a result of the TEM observation, nickel nanoparticles having sizes of 2 to 4 nm, dispersed on the carbon black particles, were found.

The nanoparticle-supporting carbon black particles and platinum acetylacetonate were added to dioctyl ether, and the mixture was heated up to 200° C. while stirred by a magnet stirrer and was then held at 200° C. for 30 minutes while stirred by a magnet stirrer.

The mixture was cooled to room temperature, and the product was separated from the dioctyl ether by filtration, and was observed by TEM. As a result of the TEM observation, fine particles dispersed on the carbon black particles were found. In a TEM image of the product, the center and surface of the fine particle were different in contrast. Based on the result, it was assumed that Pt was substitution-deposited on a surface of the nickel nanoparticle in the above heating process to form a platinum layer. Such carbon black particles may be hereinafter referred to as “catalyst-supporting particles”.

The thickness of the platinum layer of the catalyst-supporting particle was measured by a high-resolution TEM. As a result, the platinum layer had a thickness of 0.4 nm.

Catalyst-supporting particles having different platinum layer thicknesses were produced in the same manner as above except that the heat-holding time for heating the dioctyl ether containing the nanoparticle-supporting carbon black particles and the platinum acetylacetonate was variously changed.

Part of the obtained catalyst-supporting particles were heated to 950° C. by a thermal analyzer to remove carbon components, and the catalyst loading was obtained based on the ratio between the initial weight and the weight measured after the heating. Meanwhile, an ink containing the catalyst-supporting particles was prepared, and the ink was applied to a rotating electrode base having a diameter of 5 mm and a thickness of 4 mm, composed of a glassy carbon, whereby a sample for evaluation was prepared.

The ink containing the catalyst-supporting particles was prepared by mixing the particles with water at a concentration of 1 g/l, and by applying an ultrasonic wave to the mixture for 5 minutes using an ultrasonic homogenizer to disperse the particles. In the application process, 15 μl of the ink was sampled and dropped on the glassy carbon base and dried in the air at room temperature, and 15 μl of an aqueous Nafion solution having a concentration of 0.05% by weight was sampled and dropped on the ink and dried in the air at room temperature.

The thus-obtained sample was subjected to a catalytic activity evaluation and an eluted transition metal amount measurement using the linear sweep voltammetry in the same manner as above. The relations of the measurement results to the platinum layer thickness are shown in Table 6.

TABLE 6

| Average | | | | | | |
|---|---|---|---|---|---|---|
| diameter of | | | | | | |
| underlayer | | | | Current | | |
| particles | Holding | | Catalyst | value at | Amount | |
| (Ni) | time | Pt thickness | loading | 0.7 V | of eluted Ni | |
| [nm] | [min] | [nm] | [weight %] | [mA] | [ng/ml] | Evaluation |
| 3.2 | 100 | 2.0 | 39.6 | 0.828 | 0 | poor |
| 3.3 | 80 | 1.2 | 39.3 | 0.824 | 0 | poor |
| 3.2 | 50 | 0.9 | 38.8 | 0.940 | 0 | excellent |
| 3.3 | 30 | 0.4 | 40.1 | 0.942 | 0 | excellent |
| 3.1 | 20 | 0.3 | 38.9 | 0.105 | 8 | poor |

Aside from the above, a toluene solution of dicobalt octacarbonyl was prepared in a glove box under an inert atmosphere, and oleylamine was added to the toluene solution. The mixture was heated up to 110° C. and was then held at 110° C. for 6 hours, so that the dicobalt octacarbonyl was thermally decomposed to generate cobalt nanoparticles.

Next, ethanol was added to the mixture, the cobalt nanoparticles were precipitated by using a centrifugal separator, and the supernatant liquid was removed. Nonane was added to the residual precipitate to prepare a cobalt nanoparticle-dispersed nonane solution. Carbon black particles (trade name: Valcan X72) and nonane were added to the cobalt nanoparticle-dispersed nonane solution, and the resultant liquid was stirred overnight by a magnet stirrer.

Next, the solvent was removed from the liquid by a rotary evaporator, and the product was dried by a vacuum dryer, and was observed by TEM. As a result of the TEM observation of the obtained product, cobalt nanoparticles having sizes of 10 to 15 nm, dispersed on the carbon black particles, were found.

Next, the nanoparticle-supporting carbon black particles and platinum acetylacetonate were added to dioctyl ether, and the mixture was heated up to 200° C. while stirred by a magnet stirrer and was then held at 200° C. for a predetermined time while stirred by a magnet stirrer.

The mixture was cooled to room temperature, and the product was separated from the dioctyl ether by filtration, and was observed by TEM. As a result of the TEM observation, fine particles dispersed on the carbon black particles were found. In a TEM image of the product, the center and surface of the fine particle were different in contrast from each other. Thus, also in this example, Pt was substitution-deposited on a surface of the cobalt nanoparticle in the above heating process to form a platinum layer.

The catalyst-supporting particles were subjected to a platinum layer thickness measurement, a catalyst loading determination, a catalytic activity evaluation, and an eluted transition metal amount measurement in the same manner as above. The relations of the measurement results to the platinum layer thickness are shown in Table 7.

TABLE 7

| Average | | | | | | |
|---|---|---|---|---|---|---|
| diameter of | | | | | | |
| underlayer | | | | Current | | |
| particles | | Pt | Catalyst | value at | Amount of | |
| (Co) | Holding time | thickness | loading | 0.7 V | eluted Co | |
| [nm] | [min] | [nm] | [weight %] | [mA] | [ng/ml] | Evaluation |
| 11.3 | 100 | 2.0 | 39.9 | 0.751 | 0 | poor |
| 12.0 | 80 | 1.2 | 39.2 | 0.755 | 0 | poor |
| 11.5 | 50 | 0.9 | 38.6 | 0.851 | 0 | excellent |
| 11.9 | 40 | 0.4 | 38.2 | 0.852 | 0 | excellent |
| 12.2 | 30 | 0.3 | 38.8 | 0.081 | 9 | poor |

It is clear from Tables 6 and 7 that, also in the case of using catalyst-supporting particles, the catalyst with a platinum layer thickness of at least 0.4 nm and less than 1 nm has a high catalytic activity and a small underlayer elution amount.

Although certain preferred embodiments of the present invention have been shown and described in detail, it should be understood that various changes and modifications may be made therein without departing from the scope of the appended claims.

What is claimed is:

1. A catalyst for accelerating an oxidation-reduction reaction, comprising an underlayer and a platinum layer formed thereon, wherein the underlayer comprises a transition metal other than platinum group metals or an alloy thereof, and the platinum layer has a thickness of at least 0.4 nm but less than 1 nm.

2. A catalyst according to claim 1, wherein the catalyst is used in an electrode of a fuel cell.

3. A catalyst according to claim 2, wherein the catalyst is used in a cathode of the fuel cell.

4. A catalyst according to claim 1, wherein the transition metal is Ti, V, Cr, Mn, Fe, Co, Ni, Cu, Zn, Mo, W, or Zr.

5. A catalyst according to claim 4, wherein the transition metal is Co, Ni, Fe, or Cu.

6. A catalyst according to claim 1, wherein the alloy of the transition metal is a Ti—W alloy, a Ti—Ni alloy, a Ti—Co alloy, a Ti—V alloy, a Ti—Mo alloy, a W—Zr alloy, a W—Cr alloy, or a W—Ni alloy.

7. A catalyst according to claim 1, wherein a film of the platinum layer is laminated on a film of the underlayer.

8. A catalyst according to claim 1, wherein the underlayer comprises a particle and is covered with a film of the platinum layer.

9. A catalyst according to claim 8, wherein the underlayer is supported on a surface of another particle.

10. A catalyst according to claim 9, wherein the other particle is a carbon particle.
